(19) United States
(12) Patent Application Publication
(10) Pub. No.: US 2004/0187644 A1
(43) Pub. Date: Sep. 30, 2004

(54) Method for manufacturing a razor blade

(75) Inventors: Dennis J. Peterlin, Stratford, CT (US); David C. Coffin, Hamden, CT (US)

Correspondence Address: Richard R. Michaud, McCormick, Paulding & Huber LLP, CityPlace II, 185 Asylum Street, Hartford, CT, 06103, US

(73) Assignee: Eveready Battery Company, Inc., Westlake, OH

(21) Appl. No.: 10/786,267

(22) Filed: Feb. 25, 2004

Related U.S. Application Data
(60) Provisional application No. 60/450,200, filed on Feb. 25, 2003.

(51) Int. Cl. B26B 21/54

(52) U.S. Cl. 76/104.1; 30/346.57

(57) ABSTRACT

A method for manufacturing a razor blade. In the method, a razor blade blank is coined to produce a razor blade with a cutting edge. It is preferred that the razor blade blank be unhardened for coining. Additional manufacturing steps that may be performed are hardening of the razor blade at least in the vicinity of the cutting edge, and finishing the cutting edge. The method allows for the cost-effective manufacture of razor blades having both linear and non-linear cutting edges.

### CROSS-REFERENCE TO RELATED APPLICATIONS

This application is entitled to the benefit of and incorporates by reference essential subject matter disclosed in Provisional Patent Application No. 60/450,200 filed on Feb. 25, 2003.

### FIELD OF THE INVENTION

The invention generally relates to material processing and, more particularly, to the processing of material to create a cutting edge for a razor blade.

### BACKGROUND OF THE INVENTION

In a wet shaving operation, hair is typically removed from a hirsute surface by a razor blade. The razor blade has a sharp edge, generally referred to as the cutting edge, that severs the hair from the surface. The overall comfort of the shave and thus the resulting consumer satisfaction with the razor blade is highly dependent upon the angle of the cutting edge relative to the hirsute surface, and the sharpness, smoothness and uniformity of the cutting edge.

Since the development of the mass-produced razor blade, grinding one or both generally parallel surfaces of a metal razor blade blank to create intersecting surfaces has been the predominate method used to form cutting edges. Following the grinding operation, the surfaces are finished to deburr, or smooth, the ground surfaces, and sharpen the cutting edge in an operation commonly referred to as stropping. Originally, stropping involved dragging a surface of the cutting edge over a leather strap.

Grinding followed by stropping has proven to be an efficient and cost effective manufacturing process for mass-producing razor blades having a linear cutting edge. This is due in large part to the configuration of the machinery used to perform the grinding.

A razor blade with non-linear cutting edges, however, offers potential shaving benefits to consumers. One such non-linear razor blade design incorporates a series of circular apertures, each having a perimeter that is ground and finished to create surfaces that define a cutting edge.

A problem associated with the use of grinding and stropping to create a non-linear cutting edge, such as in the perimeter of a circular aperture, is that it is costly. In addition, it results in a cutting edge that is not properly angled relative to the hirsute surface to provide the comfortable shave demanded by consumers. As a result, an additional process step of bending the cutting edge to a desired angle is required.

In an effort to make the manufacturing of non-linear cutting edges more cost efficient, various alternatives to the traditional grinding and stropping method have been proposed. In one method, coining is employed to form round dimples of generally constant cross-section in unhardened steel. After hardening, the top of the dimple is removed by any one of several processes in such a way as to create surfaces that define a cutting edge. The cutting edge is then finished, such as by chemically etching.

Based on the foregoing, it is the general object of the present invention to overcome the problems and drawbacks with, or improve upon, the prior art.

### SUMMARY OF THE INVENTION

The present invention resides in one aspect in a method wherein a razor blade blank is first subjected to squeezing in a closed set of dies, an operation referred to by those skilled in the pertinent art to which the present invention pertains as “coining.” The coining operation shapes the razor blade blank into a razor blade having a cutting edge. After coining, at least a portion of the cutting edge may be hardened and then the cutting edge may be finished, creating the finished razor blade.

Coining the cutting edge permits different shaped cutting edges, such as linear, non-linear, and combinations thereof, to be formed that would otherwise not be economical or even possible employing traditional methods.

### BRIEF DESCRIPTION OF THE DRAWINGS

FIG. 1 is a plan view of a razor blade employing a plurality of apertures, each defined by a sharpened peripheral edge.

FIG. 2 is a cross- sectional view of the razor blade of FIG. 1 taken along line 2-2.

FIG. 3 is an enlarged view of a portion of the peripheral edge of an aperture of FIG. 2 as indicated by the circled area labeled 3.

FIGS. 4A and 4B are a partial cross-sectional side view of a portion of a razor blade bank and a resulting coined portion of a razor blade, respectively.

FIG. 5 is a partial cross-sectional side view of a portion of a razor blade coined using the disclosed method.

FIG. 6A and 6B are plan views of a razor blade blank and the resulting coined razor blade, respectively.

FIG. 7 is a cross-sectional view of the razor blade of FIG. 6 taken along line 7-7.

FIG. 8 is an enlarged cross-sectional view of a portion of the razor blade of FIG. 7 as indicated by the circled area labeled 8.

FIG. 9 depicts an alternate cutting edge position for a razor blade of the type depicted in FIG. 6B.

FIG. 10 is a plan view of a razor blade manufactured in accordance with the method of the present invention.

FIG. 11 is a cross-sectional view of the razor blade of FIG. 10 taken along line 11-11.

FIG. 12 is an enlarged top view of the razor blade of FIG. 10 as indicated by the circled area labeled 12.

FIG. 13 is an enlarged side view of the razor blade section of FIG. 11 as indicated by the circled area labeled 13.

FIG. 14 is a plan view of a razor blade manufactured in accordance with the method of the present invention.

FIG. 15 is a cross-sectional view of the razor blade of FIG. 14 taken along line 15-15.

FIG. 16 is a perspective view of the razor blade of FIG. 14.

FIG. 17 is an enlarged perspective top view of the razor blade of FIG. 16 as indicated by the circled area labeled 17.

FIG. 18 is an enlarged side view of the razor blade section of FIG. 15 as indicated by the circled area labeled 18.

FIG. 19 is a plan view of a razor blade manufactured in accordance with the method of the present invention.

FIG. 20 is a cross-sectional view of the razor blade of FIG. 19 taken along line 20-20.

FIG. 21 is a top perspective view of the razor blade of FIG. 19.

FIG. 22 is an enlarged perspective view of the razor blade of FIG. 21 indicated by the circled area labeled 22.

FIG. 23 is an enlarged cross-sectional view of the razor blade of FIG. 20.

FIG. 24 is a plan view of a razor blade manufactured in accordance with the method of the present invention.

FIG. 25 is a cross-sectional side view of the razor blade of FIG. 24 taken along line 25-25.

FIG. 26 is a top perspective view of the razor blade of FIG. 24.

FIG. 27 is an enlarged view of the razor blade of FIG. 26 indicated by the circled area labeled 27.

FIG. 28 is an expanded view of the cross-section of FIG. 25.

FIG. 29 is an expanded view of the razor blade of FIG. 28 indicated by the circled area labeled 29.

### DETAILED DESCRIPTION OF THE PREFERRED EMBODIMENTS

The method of the present invention is initially explained within the context of manufacturing a razor blade having a plurality of generally circular apertures, each having a perimeter defining a cutting edge. Other razor blades that may be manufactured using the method are then discussed.

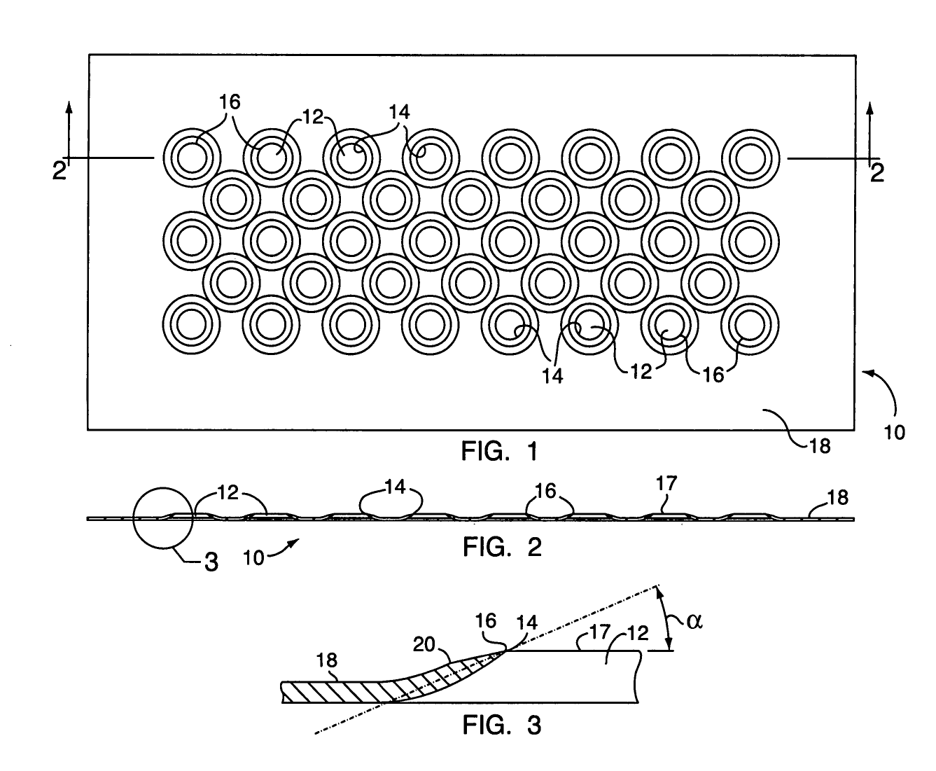

As shown in FIGS. 1 through 3, a razor blade 10 has a plurality of generally circular apertures 12. Each aperture 12 has a perimeter 14 that defines a cutting edge 16. As shown in FIGS. 2 and 3, each cutting edge 16 has a leading edge 17. The leading edge 17 is positioned off but generally parallel to a top surface 18 of the razor blade 10. The cutting edge 16 is also inclined at an angle ∝relative to the top surface 18. This angle ∝ establishes an angle of attack for the cutting edge 16 relative to a shaver's skin (not shown). For shaving comfort, the angle ac is preferably in the range of 10 degrees to 30 degrees and most preferably in the range of 19 degrees to 25 degrees. The cutting edge 16 has a thickness at a root 20 thereof preferably in the range of 0.08 mm to 0.25 mm.

The method of the present invention will now be described within the context of forming an aperture 12 having a perimeter with a cutting edge 16 as described above. The method, however, is generally applicable to forming all the apertures 12.

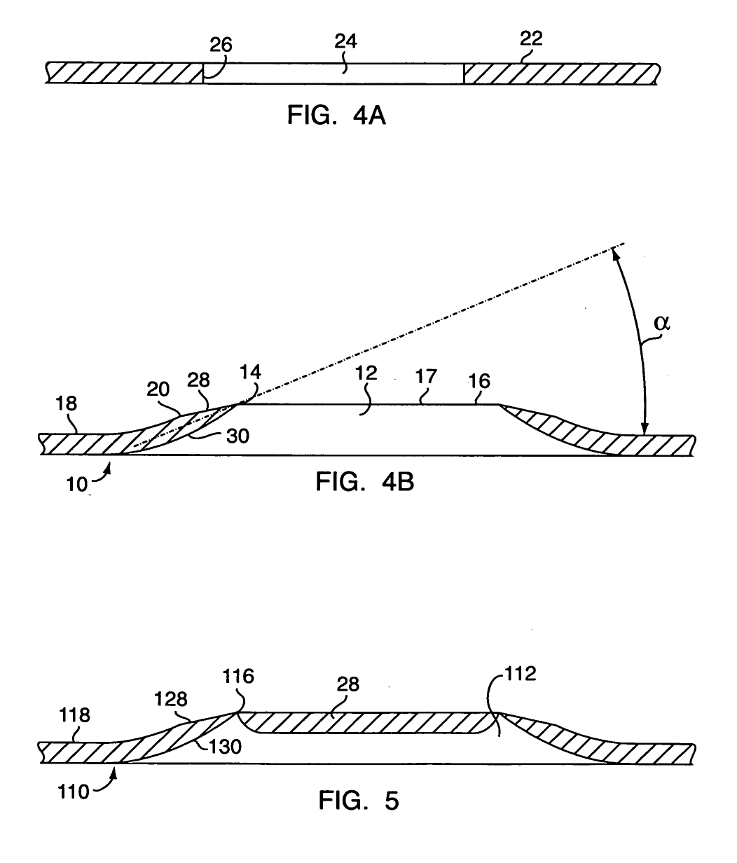

A razor blade blank 22 into which an aperture 12 with a cutting edge 16 will be formed is depicted in FIG. 4A. As an initial step, a generally round bore 24 having a peripheral surface 26 is created in the razor blade blank 22, which is a piece of plate stock, i.e., having generally parallel surfaces. At this stage of the process, the material from which the razor blade blank 22 is manufactured is preferably in a workable form, generally referred to by those skilled in the relevant art as “unhardened.” The razor blade blank 22 is coined defining a razor blade 10, FIG. 4B, having the cutting edge 16. In the coining operation, the peripheral surface 26 of the razor blade blank 22 is displaced and compressed to create two angled surfaces 28, 30 that intersect to define the cutting edge 16. The cutting edge 16 is coined at an angle ∝ defined relative to the top surface 18 of the razor blade 10, which in this case is also the top surface of the razor blade blank 22. While the cutting edge 16 has been shown inclined at an angle ∝ as to the top surface 18, the invention should not be considered so limited, as it could be generally parallel, or declined, with respect thereto. The coining operation also positions the leading edge 17 generally parallel to the top surface 18.

After coining, at least a portion of the cutting edge 16 is hardened preferably in the area proximate the leading edge 17. The method of hardening is based on the material from which the cutting edge 16 is made. In the case where the material is a metal such as steel, hardening might involve heat treatment. Where the material is a plastic, hardening such as by exposure to infrared light might be appropriate. It is possible that during hardening the entire razor blade may be hardened.

The cutting edge 16 is then finished thereby finishing the razor blade 10. Chemical etching may be used to finish the cutting edge 16. Other methods, however, such as stropping and grinding are considered within the scope of the invention. Finishing may smooth and deburr the surfaces 28, 30 as well as provide the final removal of material from the surfaces to obtain the desired sharpness of the cutting edge 16.

FIG. 5 shows a variation on the above-described method. As this method, is similar to the method described above, similar elements of the razor blade 110 will be given the same reference number preceded by a number 1. Unlike the previous method, the razor blade blank (not shown) is not initially bored. Thus, the coining operation shapes the angled surfaces 128, 130 that define the cutting edge 116, but a slug 28 of material remains, blocking the to be created aperture 112. The slug 28 can be removed by any one of a number of methods, such as punching or by chemical etching thereby creating the aperture 112. As with the prior method, at least a portion of the cutting edge 116 is hardened and then the cutting edge is finished to finish the razor blade.

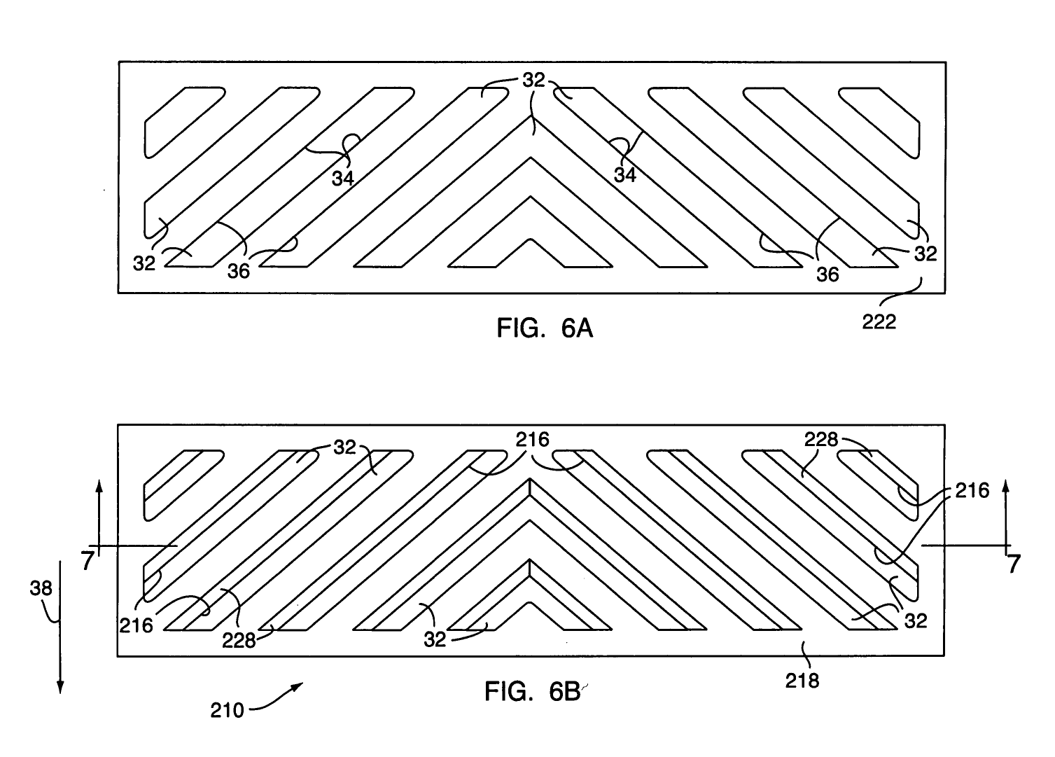

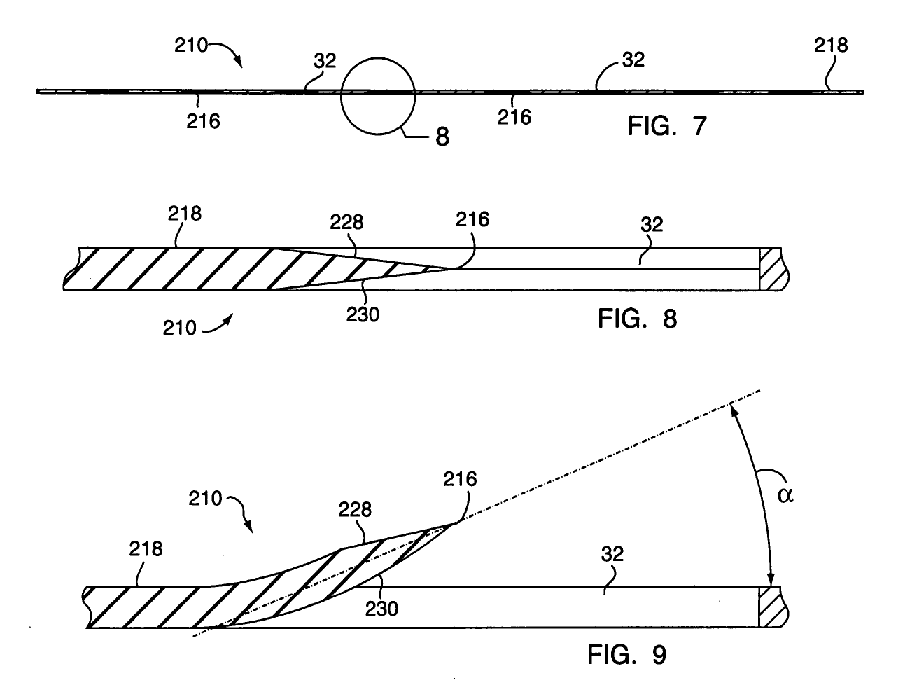

FIGS. 6 through 9 show a second razor blade 210 that may be manufactured by the above-described method. As many of the features of this razor blade 210 are similar to the razor blade 10 previously discussed and the razor blade blank 22 from which it was manufactured, similar elements will be given similar reference numbers preceded by the number 2. FIG. 6A depicts a razor blade blank 222 from which the razor blade 210, depicted in FIG. 6B, may be coined. The razor blade blank 222 has an array of performed slots 32, each having a perimeter 34. As shown in FIG. 6B, after coining a linear perimeter portion 36 of the perimeter 34 of each slot 32 has shaped therein intersecting surfaces 228, 230 defining a cutting edge 216. All the cutting edges 216 are aligned one to the other such that the cutting edges have a common cutting direction indicated by an arrow 38. As with the previous razor blade 10, the cutting edge 216 can be planar to (See FIG. 8), or inclined at an angle ∝ relative to (See FIG. 9) the top surface 218.

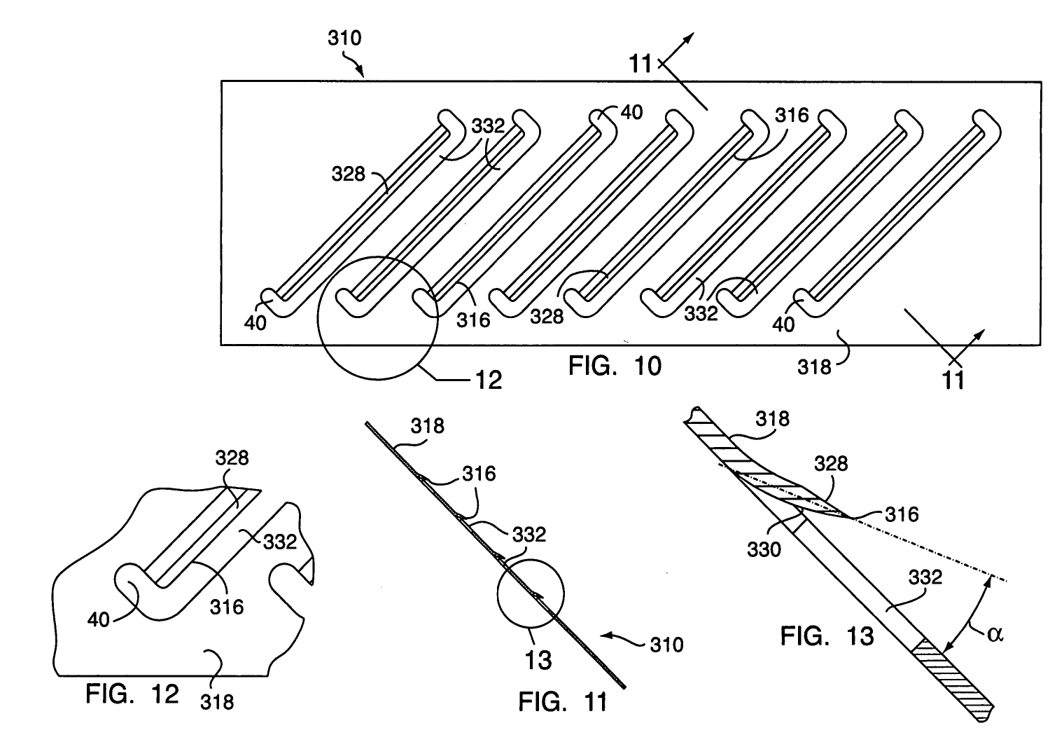

FIGS. 10 through 13 illustrate a third razor blade 310 that may be manufactured by the above-described method. As many of the features of this razor blade 310 are similar to the previously discussed razor blades 10, and 210, similar elements will be given similar reference numbers preceded by the number 3. The razor blade 310 was coined from a razor blade blank (not shown) having a plurality of performed slots similar to slot 332, each having cutouts at each end similar to cutouts 40. Coined into a linear perimeter portion of each slot of the razor blade blank are intersecting surfaces 328, 330 that define a cutting edge 316. The cutting edges 316 are generally parallel one to the other. Like the second razor blade 210, each cutting edge 316 is generally linear. In this third razor blade 310, the cutting edge 316 is inclined at an angle a relative to the top surface 318.

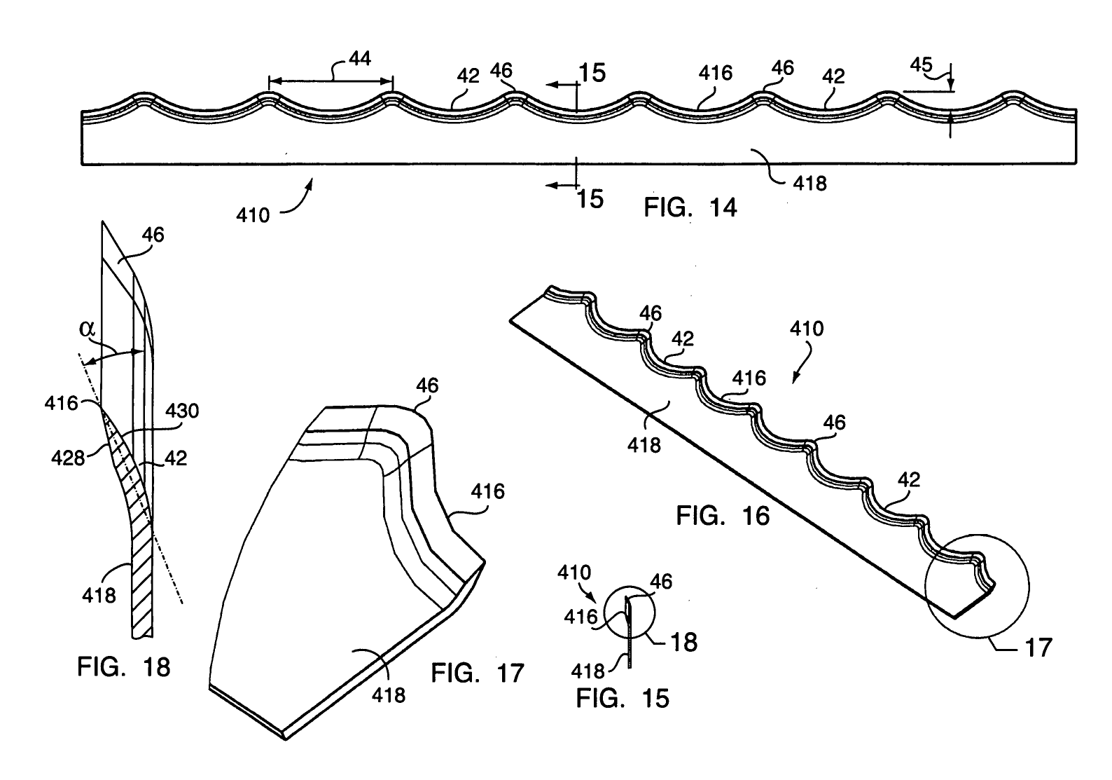

FIGS. 14 through 18 illustrate a fourth razor blade 410 that may be manufactured by the above-described method. As many of the features of this razor blade 410 are similar to the previously discussed razor blades 10, 210, and 310, similar elements will be given similar reference numbers preceded by the number 4. The razor blade 410 has been coined from a razor blade blank (not shown) having a perimeter portion that is continuously scalloped similar to continuous scalloped cutting edge 416. The scalloped portion of the perimeter portion of the razor blade blank was coined to shape cutting edge 416. In the razor blade 410, each scallop 42 of the cutting edge 416 has a pitch 44 (peak to peak distance). The pitch 44 is preferably between 0.1 and 0.39 mm. Also, each scallop 42 has a depth 45 (from peak to trough of the cutting edge 416) of between 0.1 and 6.0 mm. Between any two scallops 42, the cutting edge 416 adopts an inflection curve 46 having a radii in the range of 0.1 to 1.0 mm. While the scalloped cutting edge 416 has been depicted as regularly formed, this is not a requirement of the invention as it could be irregular; thus the invention should not be considered so limited.

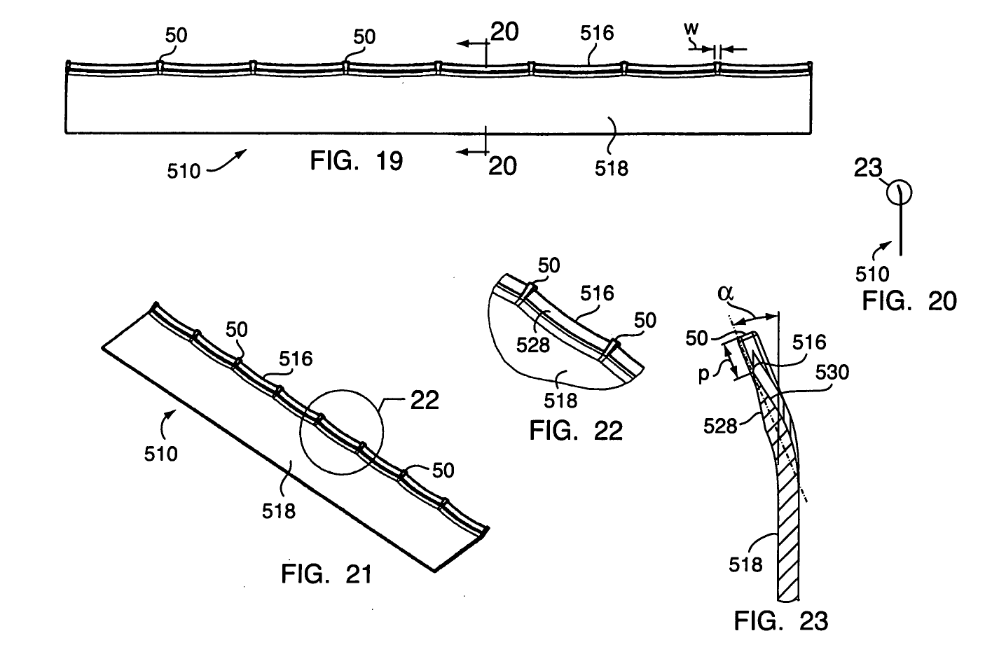

FIGS. 19 through 23 illustrate a fifth razor blade 510 that may be manufactured by the above-described method. As many of the features of this razor blade 510 are similar to the previously discussed razor blades 10, 210, 310 and 410, similar elements will be given similar reference numbers preceded by the number 5. This razor blade 510 like the fourth razor blade 410 was manufactured from a razor blade blank (not shown) having a non-linear perimeter portion similar to the non-linear cutting edge 516, which was coined to create the cutting edge 516. As a result, the razor blade 510 has a non-linear cutting edge 516, which in this case is also scalloped. Unlike the fourth razor blade 410 that had an inflection curve 46 between adjacent scallop sections 42, this razor blade 510 has skin guides 50. The skin guides 50, which were also shaped during the coining of the cutting edge 516, act to control the contract of the skin with the cutting edge 516 during a shaving operation thereby increasing shaving safety and comfort. Each skin guide 50 is preferably 0.08 to 0.5 mm wide (indicated by the letter w) and projects outwardly 0.02 to 1.0 mm beyond the cutting edge 516 (indicated by the letter p).

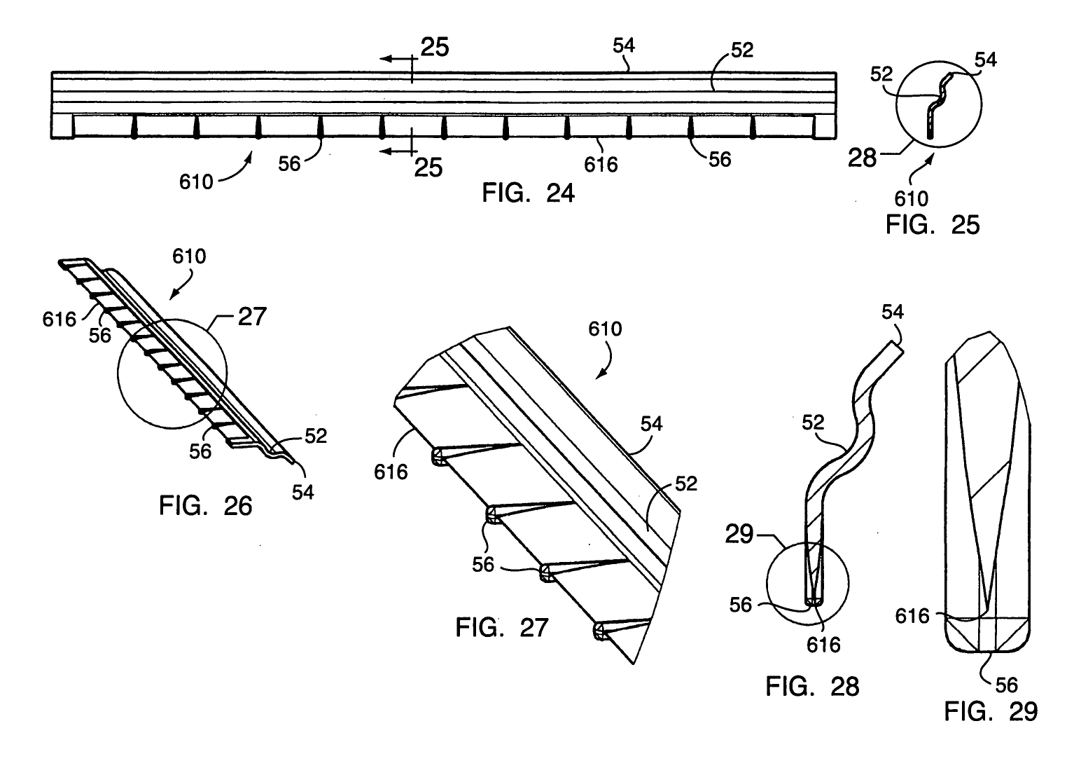

FIGS. 24 through 29 illustrate a sixth razor blade 610 that may be manufactured by the above-described method. As many of the features of this razor blade 610 are similar to the previously discussed razor blades 10, 210, 310, 410 and 510, similar elements will be given similar reference numbers preceded by the number 6. The cutting edge 616 of the razor blade 610 was coined in a perimeter of a razor blade blank (not shown) similar to the cutting edge 616. During coining, not only was the cutting edge 616 shaped but also corrugations 52. The longitudinal corrugations 52 increase the resistance to bending of the cutting edges 616 during a shaving operation. As a result of the corrugations 52, the razor blade 610 can be narrower (from the cutting edge 616 to the back of the razor blade denoted by the reference number 54). Narrower razor blades 610 are preferred due to the ability to increase rinsability of the razor blade when the razor blade is placed in a cartridge (not shown). Skin guides 56, which were also formed during the coining operation, project outwardly from and interrupt the cutting edge 616. These skin guides 56 have similar characteristics to the skin guides 50 discussed above.

Although the present invention has been described in considerable detail with reference to certain preferred versions thereof, other versions are possible. In particular, the cutting edge has been shown as being created by shaping two surfaces. This, however, is not required as only one surface needs to be shaped to another. Additionally, the cutting edges have been depicted as linear or non-linear for any given razor blade, combination cutting edges are also considered with the scope of the invention. Therefore, the spirit and scope of the invention should not be limited to the description of the preferred versions contained herein.

What is claimed is:

1. A method for manufacturing a razor blade comprising the step of:
providing material in the form of a razor blade blank;
coining the razor blade blank to form a razor blade with a cutting edge; and
finishing the cutting edge to form a finished razor blade.

2. The method of claim 1 wherein said step of providing material in the form of a razor blade blank includes providing unhardened material.

3. The method of claim 2 further including the step of hardening at least a portion of the cutting edge.

4. The method of claim 3 wherein the step of finishing the cutting edge includes using chemical etching.

5. The method of claim 1 wherein the step of providing material in the form of a razor blade blank includes providing material with at least one bore therein defined by a perimeter and wherein the step of coining includes shaping at least a portion of the perimeter to define the cutting edge.

6. The method of claim 1 further including the step of providing a razor blade blank with at least one bore defined by a perimeter having at least two perimeter portions and wherein the step of coining includes shaping less than all the perimeter portions into the cutting edge.

7. The method of claim 1 wherein the step of coining includes shaping in the razor blade blank at least one skin guide.

8. The method of claim 7 wherein the at least one skin guide interrupts the cutting edge.

9. The method of claim 8 wherein the at least one skin guide projects beyond the cutting edge.

10. The method of claim 1 including the further step of providing a razor blade blank having a perimeter at least a portion of which is non-linear.

11. The method of claim 10 wherein the step of coining includes shaping at least a portion of the non-linear perimeter into the cutting edge.

12. The method of claim 11 wherein at least a portion of the non-linear cutting edge is scalloped.

13. The method of claim 1 wherein the step of coining includes shaping in the razor blade blank a corrugation.

14. The method of claim 1 wherein the step of coining includes giving at least a portion of the cutting edge a non-zero angle relative to a top surface of the razor blade.

15. The method of claim 14 wherein the step of coining includes locating a leading edge of the cutting edge generally parallel to the top surface.

16. A razor blade comprising:
a cutting edge having a leading edge; and
a skin guide extending from the cutting edge.

17. The razor blade of claim 16 wherein the skin guide interrupts the leading edge.

18. The razor blade of claim 16 wherein the skin guide projects outwardly from the leading edge.

19. The razor blade of claim 16 wherein the leading edge has at least a portion that is non-linear.
